(19) United States
(12) Patent Application Publication
(10) Pub. No.: US 2025/0262965 A1
(43) Pub. Date: Aug. 21, 2025

(54) FAST-CHARGING STATION FOR ELECTRIC VEHICLES

(71) Applicant: ETI CA BATTERY INC., New Taipei City (TW)

(72) Inventor: Wei-Chen WU, New Taipei City (TW)

(73) Assignee: ETI CA BATTERY INC., New Taipei City (TW)

(21) Appl. No.: 18/633,271

(22) Filed: Apr. 11, 2024

(30) Foreign Application Priority Data
Feb. 16, 2024 (TW) 113105421

(51) Int. Cl. B60L 53/31; B60L 53/22; B60L 53/53

(52) U.S. Cl. CPC B60L 53/31; B60L 53/22; B60L 53/53

(57) ABSTRACT

A fast-charging station for electric vehicles includes a charger, an energy storage battery, fast-charging piles, a controller, and a display panel. The charger receives and converts alternating current utility power into direct current power for charging the energy storage battery. When the energy storage battery is fully charged, the energy storage battery can supply power to the fast-charging pile and then employs the fast-charging pile to quickly charge the electric vehicle. The controller can control the charging process of the fast-charging pile for the electric vehicle and detect the power information of the energy storage battery, the electric vehicle, and the fast-charging pile. The power information is displayed by the display panel. The fast-charging station for electric vehicles can be combined with existing power facilities without redistributing power or constructing power distribution facilities, reducing construction costs and promoting the popularization of fast-charging piles.

### BACKGROUND OF THE INVENTION

This application claims priority for the TW patent application Ser. No. 113105421 filed on 16 Feb. 2024, the content of which is incorporated by reference in its entirely.

### Field of the Invention

The present invention relates to a technical field for charging piles, particularly to a fast-charging station for electric vehicles that can reduce construction costs.

### Description of the Related Art

In order to achieve the goals of the Paris Agreement, countries around the world are committed to promoting the development of the electric vehicle industry to reduce greenhouse gas emissions. Charging piles are the future infrastructure of the electric vehicle industry and the popularization of charging piles has become the primary task to promote the popularization of electric vehicles. The fast-charging piles can provide high power for charging to significantly reduce the charging time of electric vehicles. The charging power of fast-charging piles for electric vehicles must be more than 150KW and its power requirements far exceed the electricity consumption of ordinary households. Traditionally, in order to construct fast-charging piles, high-power grid construction and power distribution facilities must be built to meet the power requirements for high-power charging piles. This process requires a large amount of civil engineering and electric power engineering, such that the construction of fast-charging piles consumes time and has extreme costs. Therefore, current efforts to promote the construction of fast-charging piles often rely on government policy guidance and subsidies, resulting in limited growth in the number of charging piles. This is also an important factor hindering the popularization of electric vehicles.

### SUMMARY OF THE INVENTION

Accordingly, the primary objective of the present invention is to provide a fast-charging station for electric vehicles that can be combined with existing power facilities without redistributing power or constructing power distribution facilities. The charging station can quickly charge electric vehicles, promote the popularization of fast-charging piles, and contribute to the development and promotion of electric vehicles.

In order to achieve the foregoing objective, the present invention provides a fast-charging station for electric vehicles applied to electric vehicles. The fast-charging station includes a charger, an energy storage battery, a plurality of fast-charging piles, a controller, and a display panel. The charger is configured to receive and convert alternating current utility power into direct current power. The energy storage battery is connected to the charger and configured to receive the direct current power to be charged. The fast-charging piles are connected to the energy storage battery and configured to receive power stored in the energy storage battery to charge the electric vehicles respectively. The energy storage battery and the controller are respectively connected to the fast-charging piles. The controller is configured to control the charging processes of the electric vehicles by using the fast-charging piles and to detect the power information of one of the energy storage battery, the electric vehicles, and the fast-charging stations. The display panel is connected to the controller and configured to receive and display the power information.

According to an embodiment of the present invention, the source of the alternating current utility power is household electricity, commercial electricity, or industrial electricity.

According to an embodiment of the present invention, the power information includes the capacity of the energy storage battery, the remaining power of the energy storage battery, the number of the electric vehicles supplied by the remaining power of the energy storage battery, the remaining power of the electric vehicles, the number of electric vehicles being charged, or time required for fully charging the electric vehicles.

According to an embodiment of the present invention, the charging processes include the charging power or the charging capacity of the fast-charging piles.

According to an embodiment of the present invention, the fast-charging station for the electric vehicles further includes a server connected to the controller and a user electronic device through a network. The server is configured to obtain the charging station information and the power information of the fast-charging piles and provide the relevant charging station information and the power information for the user electronic device according to location information generated by the user electronic device.

According to an embodiment of the present invention, the charging station information includes the locations of the fast-charging piles or the names of charging stations.

According to an embodiment of the present invention, a user application program is built in the user electronic device. The user application program is configured to provide an electronic map and mark the relevant charging station information and the power information on the electronic map for browsing according to the location information.

Compared with the conventional technology, the present invention has the following advantages:
1. The fast-charging station for electric vehicles of the present invention employs existing power facilities and the energy storage battery. When the energy storage battery is fully charged, it can supply power to the fast-charging pile so that the electric vehicle can be charged quickly. Compared with the conventional fast-charging piles, the fast-charging station is not only easy to construct but also low-cost, which can help accelerate the construction of fast-charging piles, thus solving the current problem with insufficient charging piles for electric vehicles.
2. The fast-charging station for electric vehicles of the present invention can set the energy storage battery to store electricity during off-peak hours when electricity prices are cheaper and employ the display panel to instantly display the power information of the energy storage battery, the electric vehicles, and the fast-charging piles, such that users clearly understand the usage scenario of the charging station to effectively utilize the charging station for fast charging.
3. The fast-charging station for electric vehicles of the present invention communicates with the user electronic device through a network. As a result, users view either relevant charging station information or charging station information of interest and power information on the electronic map. This reduces the time users spend searching and waiting to use the charging station, thereby increasing the convenience of using the charging station.

Below, the embodiments are described in detail in cooperation with the drawings to make easily understood the technical contents, characteristics and accomplishments of the present invention.

### BRIEF DESCRIPTION OF THE DRAWINGS

FIG. 1 is a block diagram showing a fast-charging station for electric vehicles according to an embodiment of the present invention;

FIG. 2 is a schematic diagram showing a display panel of a fast-charging station for electric vehicles according to an embodiment of the present invention;

FIG. 3 is a schematic diagram showing a display panel of a fast-charging station for electric vehicles in a charging process according to an embodiment of the present invention; and

FIG. 4 is a schematic diagram showing a display panel of a fast-charging station for electric vehicles that displays information on an electronic map according to an embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

The technical solutions used in the embodiments of the present invention are used to more clearly illustrate the technical solutions of the present invention. Therefore, they are only used as examples and should not be used to limit the scope of the present invention unless otherwise specified. In the description of the specification, many specific details are provided to enable the reader to have a more complete understanding of the present invention. However, the present invention may still be implemented with some or all of the specific details omitted. In addition, well-known steps or elements are not described in detail to avoid unnecessary limitations in the present invention. Without conflict, the embodiments and features in the embodiments of the present invention may be combined with each other arbitrarily. It should be noted that, unless otherwise specified, all technical and scientific terms used in the present invention have the same meanings as commonly understood by a person having ordinary skill in the art.

As described in the conventional technology, the conventional fast-charging piles are easily time-consuming and costly to construct, resulting in the insufficient construction of charging piles and hindering the popularization of electric vehicles. In order to solve the foregoing technical problems, the basic idea of the present invention is to provide a fast-charging station for electric vehicles. As long as existing power facilities are used, electric vehicles can be quickly charged, thereby greatly reducing the difficulty and cost of constructing fast-charging piles. This will help increase the popularity of fast-charging piles, expecting to promote the popularization of electric vehicles.

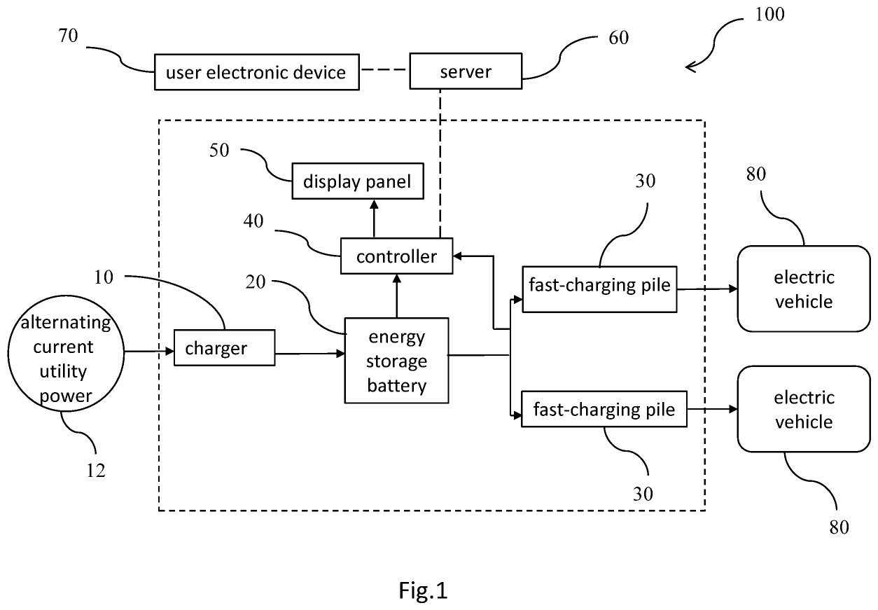

Please refer to FIG. 1. FIG. 1 is a block diagram showing a fast-charging station for electric vehicles according to an embodiment of the present invention. A fast-charging station 100 for electric vehicles of the embodiment mainly includes a charger 10, an energy storage battery 20, a plurality of fast-charging piles 30, a controller 40, and a display panel 50.

The charger 10 receives and converts alternating current utility power 12 into direct current power. The source of the alternating current utility power may be household electricity, commercial electricity, or industrial electricity. The charger 10 of the embodiment is implemented with a low-power charger. The low-power charger be powered by ordinary household electricity and used without industrial power distribution or special power distribution. The output power of the low-power charger is much smaller than that of the energy storage battery 20. For example, the output power of the low-power charger is lower than 30kW. The low-power charger can provide low power to charge the energy storage battery 20.

The energy storage battery 20 is connected to the charger 10. The energy storage battery 20 can receive the direct current power from the charger 10 to charge the energy storage battery 20. The energy storage battery 20 of the embodiment is implemented with a large-capacity energy storage battery. The capacity of the large-capacity energy storage battery is at least four times that of a general electric vehicle battery. Considering that the battery capacity of a current electric vehicle is 90KWh, the capacity of the energy storage battery 20 is, for example, 360 kWh or more. The charger 10 of the embodiment can be set to be used to charge the energy storage battery 20 during off-peak hours when the electricity bill is relatively cheap, which will help save electricity bills.

The fast-charging piles 30 are connected to the energy storage battery 20. The power source of the fast-charging pile 30 is the energy storage battery 20. When the power stored in the energy storage battery 20 is sufficient, the energy storage battery 20 can quickly supply power to the fast-charging pile 30 such that the electric car 80 can be charged quickly. The fast-charging pile 30 of the embodiment is specifically a direct current/direct current (DC/DC) type fast-charging pile.

The controller 40 and the energy storage battery 20 are respectively connected to the fast-charging piles 30. The controller 40 can control the charging processes of electric vehicles 80 by using the fast-charging piles 30 and to detect the power information of one of the energy storage battery 20, the electric vehicles 80, and the fast-charging stations 30. In the embodiment, the power information can include the capacity of the energy storage battery 20, the remaining power of the energy storage battery 20, the number of the electric vehicles 80 supplied by the remaining power of the energy storage battery 20, the remaining power of the electric vehicles 80, the number of electric vehicles 80 being charged, or time required for fully charging the electric vehicles 80.

The display panel 50 is connected to the controller 40. The display panel 50 can instantly display the power information obtained by the controller 40 for users to view, so that the user can clearly understand the current usage scenario of the charging station.

The fast-charging station 100 for electric vehicles of the embodiment may further include a server 60. The server 60 is connected to the controller 40 and a user electronic device (such as a mobile phone) 70 through a network. The server 60 can obtain the charging station information and the power information of the fast-charging piles 30 from the controller 40 and then stores the charging station information and power information of the charging piles 30 in a database. The user electronic device 70 obtains the location information generated by the user electronic device 70 itself or input by the user. According to the location information obtained by the user electronic device 70, the relevant charging station information and power information are searched from the database and then transmitted to the user electronic device 70. In the embodiment, the charging station information may include the locations of the fast-charging piles 30 or the names of charging stations. The user electronic device 70 may have a built-in user application program. According to the location information obtained by the user electronic device 70, the user application program provides an electronic map and marks the relevant charging station information and the power information on the electronic map for easy browsing by users.

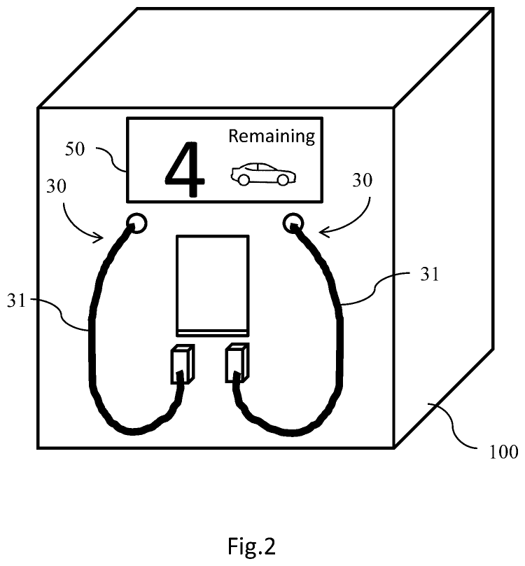

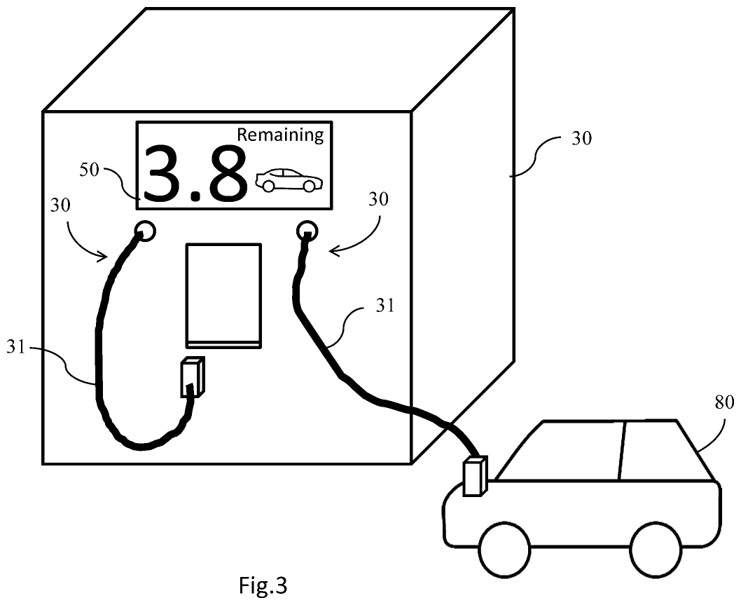

For example, when the energy storage battery is charged during the off-peak hours of general household electricity consumption, the energy storage battery can only store the power of about 4 to 5 electric vehicles a day. The display panel can instantly display how many electric vehicles the current remaining power of the energy storage battery can supply for charging. As shown in FIG. 2, the display panel 50 displays that the remaining power of the energy storage battery can be supplied to four electric vehicles. Then, as shown in FIG. 3, an electric vehicle 80 is using the charging gun 31 of the fast-charging pile 30 to be charged and the display panel 50 instantly displays that the number of electric vehicles supplied with the remaining power is reduced to 3.8.

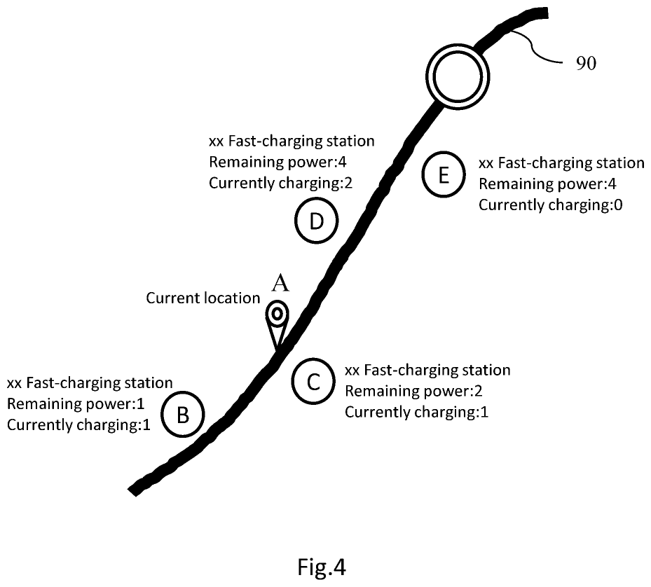

In addition, the fast-charging station for electric vehicles of the present invention can also transmit the power information of the energy storage battery, the electric vehicle, or the fast-charging pile to the user electronic device through the network, so that the user can instantly understand the usage scenario of each charging station. The user can open the user application program installed in the user electronic device (such as a mobile phone) and view the relevant charging station information and power information on the electronic map according to the location information of the user electronic device or the location information input by the user. As shown in FIG. 4, the embodiment displays on the electronic map multiple fast-charging stations B, C, D, and E for electric vehicles near the user's current location A along a highway 90 and marks the names of fast-charging stations B, C, D, and E for electric vehicles, the number of electric vehicles that can be supplied by the remaining power of the energy storage battery, and the number of electric vehicles currently being charged near each corresponding location. As a result, users can choose which fast-charging station for electric vehicles that they intend to go to for quick charging without having to go to the site in person, which can reduce the time users spend searching and waiting for use. It is very convenient for use and the utilization rate of charging stations can also be improved.

The fast-charging station for electric vehicles of the present invention can be constructed in cooperation with existing power facilities. There is no need to redistribute power and construct power distribution facilities. Therefore, it is easy to construct and low in cost to achieve intensive construction. For example, one fast-charging station for electric vehicles can be constructed every 10 kilometers along the highway to meet the required number of electric vehicles, thus solving the current problem with insufficient charging piles for electric vehicles and helping increase the popularity rate of electric vehicles to achieve the ultimate goal of net-zero carbon emissions.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A fast-charging station for electric vehicles, applied to electric vehicles, the fast-charging station comprising:
a charger configured to receive and convert alternating current utility power into direct current power;
an energy storage battery connected to the charger and configured to receive the direct current power to be charged;
a plurality of fast-charging piles connected to the energy storage battery and configured to receive power stored in the energy storage battery to charge the electric vehicles respectively;
a controller, wherein the energy storage battery and the controller are respectively connected to the plurality of fast-charging piles, and the controller is configured to control charging processes of the electric vehicles by using the plurality of fast-charging piles and to detect power information of one of the energy storage battery, the electric vehicles, and the fast-charging stations; and
a display panel connected to the controller and configured to receive and display the power information.

2. The fast-charging station for the electric vehicles according to claim 1, wherein a source of the alternating current utility power is household electricity, commercial electricity, or industrial electricity.

3. The fast-charging station for the electric vehicles according to claim 1, wherein the power information comprises a capacity of the energy storage battery, remaining power of the energy storage battery, number of the electric vehicles supplied by remaining power of the energy storage battery, remaining power of the electric vehicles, number of electric vehicles being charged, or time required for fully charging the electric vehicles.

4. The fast-charging station for the electric vehicles according to claim 1, wherein the charging processes comprise charging power or charging capacity of the plurality of fast-charging piles.

5. The fast-charging station for the electric vehicles according to claim 1, further comprising a server connected to the controller and a user electronic device through a network, wherein the server is configured to obtain charging station information and the power information of the plurality of fast-charging piles and provide the relevant charging station information and the power information for the user electronic device according to location information generated by the user electronic device.

6. The fast-charging station for the electric vehicles according to claim 5, wherein the charging station information comprises locations of the plurality of fast-charging piles or names of charging stations.

7. The fast-charging station for the electric vehicles according to claim 5, wherein a user application program is built in the user electronic device and the user application program is configured to provide an electronic map and mark the relevant charging station information and the power information on the electronic map for browsing according to the location information.
